(19) United States
(12) Patent Application Publication
(10) Pub. No.: US 2015/0176485 A1
(43) Pub. Date: Jun. 25, 2015

(54) DUAL-END DRIVE GAS TURBINE

(71) Applicant: Nuovo Pignone Srl, Florence (IT)

(72) Inventors: Marco Davide Gabelloni, Florence (IT); Gianni Acquisti, Florence (IT)

(21) Appl. No.: 14/419,278

(22) PCT Filed: Aug. 1, 2013
(86) PCT No.: PCT/EP2013/066168

§ 371 Date: Feb. 3, 2015

(30) Foreign Application Priority Data
Aug. 3, 2012 (IT) FI2012A000161

(51) Int. Cl. F02C 3/107; F01D 15/10

(52) U.S. Cl. CPC F02C 3/107; F01D 15/10

(57) ABSTRACT

A gas turbine system is described, comprising a gas turbine, at least a first load and a second load powered by the gas turbine. The gas turbine comprises: a gas generator; a low pressure turbine; a power shaft powered by the low pressure turbine. The power shaft has a first shaft end drivingly connected to the first load and a second shaft end drivingly connected to the second load. The first load and the second load are arranged at opposite sides of the gas turbine and the power shaft axially extends through the gas turbine from a first end to a second end thereof.

### FIELD OF THE INVENTION

The embodiments disclosed relate generally to gas turbines. More specifically, the embodiments relate to systems comprising gas turbines and loads driven by said gas turbines, such as electric generators or compressors.

### DESCRIPTION OF THE RELATED ART

Gas turbines are commonly used as mechanical power generators for driving a large variety of operating machines. More specifically, gas turbines are commonly used to drive large turbo machines, such as axial or centrifugal compressors. Typically gas turbines are applied in the field of natural gas liquefaction (LNG), CO₂ recovery and other sectors of the gas industry. Gas turbines are further used as mechanical power generators for driving electric generators.

FIG. 1 shows a system comprising a gas turbine and a compressor train driven by the gas turbine according to the current art.

The gas turbine is labeled 1 as a whole and comprises a gas generator 2 and a power turbine 3. The gas generator 2 includes an air compressor 4 and a high pressure turbine 5, mechanically connected to one another by means of a shaft 6. Air sucked by the compressor 4 is compressed to a high pressure value and delivered to a combustor schematically shown in 7. Fuel is mixed to the compressed air in the combustor 7 and the mixture is burned to generate a flow of combustion gases at high temperature and high pressure.

The high temperature and high pressure combustion gases expand in the high pressure turbine 5 to generate mechanical power, which is used to drive the air compressor 4 via a shaft 6. The partly expanded combustion gases are further delivered to the power turbine 3, wherein they further expand to generate additional mechanical power available on a power shaft 9. The exhausted combustion gases are then discharged through an exhauster 11.

The mechanical power generated by the high pressure turbine 5 is used entirely to drive the air compressor 4, while the mechanical power generated by the power turbine 3 is available on the power shaft 9 to drive a load labeled 13 as a whole. In the example shown, the load 13 comprises a compressor train. The compressor train is comprised of a first compressor 15 and a second compressor 17, for example centrifugal compressors of a natural gas liquefaction system. In the schematic representation of FIG. 1 the two compressors 15 and 17 are arranged in series and driven at the same speed: power is transmitted, through a load coupling 18 comprising a joint 19, to the first compressor 15 and therefrom through a second joint 21 to the second compressor 17.

This arrangement has several drawbacks. In particular, the load coupling 18 must be sized and designed for the maximum power required to drive both compressors 15 and 17. Moreover, if the compressors are of the so called vertical split type, i.e. with a casing which is formed by two or more parts coupled along a vertical splitting plane, opening of the casing of the first compressor 15 requires the second compressor 17 to be moved away from the first compressor 15.

### SUMMARY OF THE INVENTION

According to an embodiment, a gas turbine system is provided, comprising a gas turbine and at least a first load and a second load powered by the gas turbine. The gas turbine comprises: a gas generator; a low pressure turbine; a power shaft powered by the low pressure turbine. The power shaft has a first shaft end drivingly connected to the first load and a second shaft end drivingly connected to the second load. The aforesaid first load and second load are arranged at opposite sides of the gas turbine and the power shaft axially extends through the gas turbine from a first and to a second end thereof.

In some embodiments, the gas turbine is an aeroderivative gas turbine.

The first shaft end and the second shaft end are generally arranged at the so-called hot end and cold end of the gas turbine. The hot end of the gas turbine is the end at the exhauster, i.e. on the combustion gases exit side from the low pressure turbine. The cold end of the gas turbine is the end where the inlet air plenum is arranged.

The term low pressure turbine indicates the portion of the turbomachinery where the combustion gases generated by the gas generator expand to produce power, available on the power shaft for load driving purposes. The term “low pressure” is generally used to distinguish this portion of the turbomachinery from the first, high pressure turbine, arranged directly downstream the combustion chamber, where the high-pressure, high-temperature combustion gases undergo a first expansion, for driving into rotation the gas generator shaft, which in turn drives the gas turbine compressor.

According to some embodiments, the gas turbine comprises in combination and sequentially arranged: a low pressure compressor; a high pressure compressor, arranged downstream of the low pressure compressor and receiving air compressed by said low pressure compressor; a combustor, arranged for receiving compressed air from the second, high pressure compressor, as well as a gaseous or liquid fuel; a high pressure turbine receiving combustion gases from the combustor and arranged for generating mechanical power from the combustion gases partially expanding therein, the high pressure turbine being in fluid communication with the low pressure turbine. The combustion gases from the high pressure turbine expand in the low pressure turbine. The gas turbine further comprises a second shaft drivingly connecting the high pressure turbine and the high pressure compressor. The power shaft and the second shaft are coaxially arranged, and the power shaft drivingly connects the low pressure turbine and the low pressure compressor.

In some embodiments, an air bleeding arrangement can be provided between the low pressure compressor and the high pressure compressor.

In some embodiments the first load and second load comprise a first compressor and a second compressor, respectively. At least one of the aforementioned first compressor and second compressor can comprise a vertically split casing, i.e. can be a barrel-type compressor. In some embodiments both the first compressor and the second compressor comprise a respective vertically split casing, i.e. each compressor is a barrel-type compressor.

In other embodiments, one of the first load or the second load comprises a compressor with a vertically split casing, i.e is a barrel-type compressor, while the other of said first load and second load comprises a different machine, e.g. an electric generator.

By arranging two loads drivingly connected at opposite ends of a through shaft of the gas turbine, a vertically split compressor can be used, in replacement for a horizontally split compressor. This results in a higher efficiency of the system.

The compressors can be arranged and configured for processing at least one refrigeration gas in a system liquefaction of natural gas (LNG). The LNG system usually comprises one or more compressor trains, each driven by one or more gas turbine and comprising one or more compressors. The compressors are used to compress one or more different refrigerant fluids used for chilling and liquefying a natural gas for storage and/or transportation purposes. Therefore, some embodiments disclosed herein comprise: a gas turbine; at least two compressors driven by the gas turbine and arranged at opposite ends of the turbine, i.e. at the hot end and at the cold end of the turbine; at least one refrigeration circuit, wherein a refrigeration fluid flows, said refrigeration fluid being compressed by at least one of the afore mentioned compressors and flowing in at least one heat exchanger for cooling a natural gas to be liquefied.

In other embodiments, an air chilling system is provided, configured and arranged for chilling an air stream entering the gas generator. The chilling system comprises a refrigerating circuit with a compressor, which processes a refrigerating fluid circulating in the refrigerating circuit. The compressor of the refrigerating circuit is mechanically connected to one of the first shaft end and second shaft end of the gas turbine, forming one of the aforementioned first load and second load powered by the gas turbine. In some embodiments, the chilling system further comprises a heat exchanger, wherein the refrigerating fluid circulating in the refrigeration circuit exchanges heat with a secondary fluid, flowing in a secondary circuit. Said secondary circuit includes a fluid/air exchanger, wherein combustion air delivered to the gas turbine is chilled by exchanging heat with the secondary fluid flowing in the secondary circuit. Heat extracted from the air flow is transferred to the refrigerating fluid in an evaporator of the refrigeration circuit.

In some embodiments the compressor of the refrigerating circuit is drivingly connected to the first shaft end at said cold end of the gas turbine.

In a different embodiment, at least one of the first load and second load comprises an electric generator. In some embodiments, the electric generator is arranged and configured to electrically power auxiliary apparatuses of the gas turbine. The electric generator can be drivingly connected to the first shaft end of the power shaft at the cold end of said gas turbine.

According to a further aspect, the present disclosure concerns methods for operating a gas turbine system.

According to some embodiments, a method of operating a gas turbine system is provided, which comprises the following steps: providing a gas generator, a low pressure turbine and a power shaft having a first shaft end and a second shaft end accessible at a first end and at a second end of said gas turbine, respectively; drivingly connecting a first load to the first shaft end, and a second load to the second shaft end; generating mechanical power by means of the low pressure turbine; using a first part of the power generated by the low pressure turbine through a first load coupling to drive the first load and a second part of the power generated by the low pressure turbine through a second load coupling to drive the second load.

Further embodiments of the method according to the present disclosure are set forth in the dependent claims and described here below, reference being made to the accompanying drawings.

The above brief description sets forth features of various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a schematic representation of a system according to the current art;

FIG. 2 illustrates a cross-section along an axial plane of a gas turbine useful in a system according to the present disclosure;

FIGS. 3, 4 and 5 illustrate schematic representations of systems according to the present disclosure.

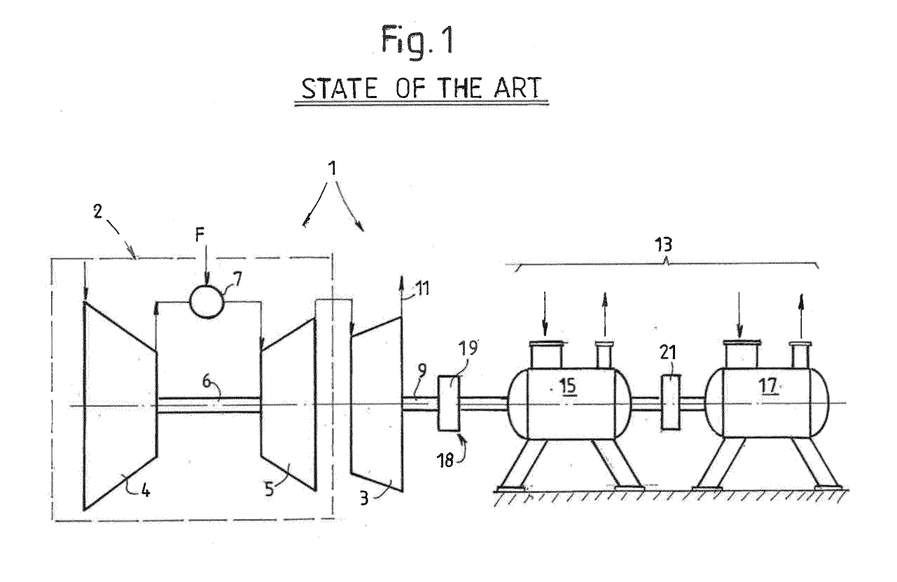

### DETAILED DESCRIPTION OF EMBODIMENTS OF THE INVENTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

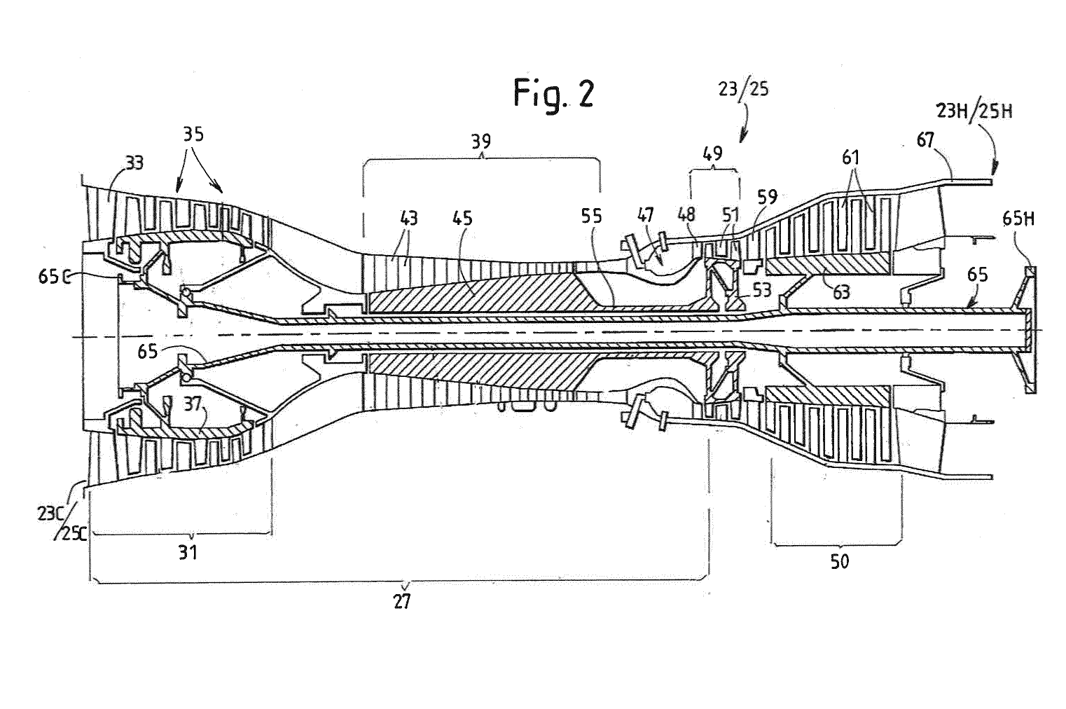

FIG. 2 illustrates a longitudinal section of an aeroderivative gas turbines 23 suitable for use in a system according to the present disclosure. The gas turbine 23 comprises a gas generator section 27 comprised of a low-pressure axial compressor 31 with a set of stationary inlet blades 33 at the suction side. A plurality of low-pressure compression stages 35 are arranged downstream of the stationary inlet blades 33. Each low-pressure compression stage 35 comprises a set of rotary blades and a set of stationary blades. The rotary blades are supported by a low pressure compressor rotor 37 and the stationary blades are supported by an outer casing of the low-pressure axial compressor 31.

The low-pressure axial compressor 31 is in fluid communication with a high-pressure axial compressor 39 arranged downstream of the low-pressure axial compressor 31. The high-pressure axial compressor 39 comprises a plurality of high-pressure compression stages 43. Each high-pressure compression stage 43 comprises a set of rotary blades and a set of stationary blades. The rotary blades are supported by a high pressure compressor rotor 45. The stationary blades are supported by the casing of the high-pressure axial compressor 39.

The outlet of the high-pressure axial compressor 39 is in fluid communication with a combustor 47. Compressed air from the high-pressure axial compressor 39 flows into said combustor 47 and gaseous or liquid fuel is mixed therewith and the air/fuel mixture is ignited to generate compressed, hot combustion gases.

Downstream of the combustor 47 a first, high pressure turbine 49 is arranged in fluid communication with the combustor 47. The high pressure turbine 49 includes a set of stationary inlet blades 48 followed by one or more expansion stages 51, each including a set of stationary blades and a set of rotary blades. The rotary blades are supported by a high pressure turbine rotor 53. The high pressure turbine rotor 53 and the high pressure compressor rotor 45 are supported by and torsionally constrained to a gas-generator shaft 55.

Expansion of the combustion gases flowing from the combustor 47 through the high pressure turbine 49 generates mechanical power, which drives the gas-generator shaft 55 and is used to power the high-pressure axial compressor 39.

The outlet of the high pressure turbine 49 is in fluid communication with the inlet of a low pressure turbine 50. The combustion gases flowing through the high pressure turbine 49 are only partly expanded and their expansion continues in the low pressure turbine 50. The inlet of the low pressure turbine 50 includes a set of stationary blades 59 supported by the casing of the turbomachinery, followed by a plurality of low-pressure expansion stages 61. Each low-pressure expansion stage 61 includes a set of rotary blades and a set of stationary blades. The rotary blades are supported by a low pressure turbine rotor 63 and the stationary blades are supported by the casing of the gas turbine 23. The low pressure turbine rotor 63 is rotationally constrained to and supported by a power shaft 65. The power shaft 65 extends through the gas turbine and coaxially to the gas generator shaft 55. The low pressure compressor rotor 37 is supported by and constrained to the same power shaft 65.

The combustion gases expanding in the low pressure turbine 50 generate mechanical power available on the power shaft 65 and partly used to drive the low-pressure axial compressor 31. The power exceeding the one required to drive the low-pressure axial compressor 31 is available to drive the load.

As can be appreciated from FIG. 2, the power shaft 65 extends from a first end 65C to an opposite second end 65H. The first end 65C of the power shaft 65 is arranged at the so-called cold end or cold side 23C of the gas turbine 23, i.e. at the cold air inlet side thereof. The second end 65H is arranged at the so-called hot end or hot side 23H of the gas turbine 23, i.e. at the side wherefrom the exhausted hot combustion gases are discharged at 67, after expansion in the high pressure turbine 49 and the low pressure turbine 50.

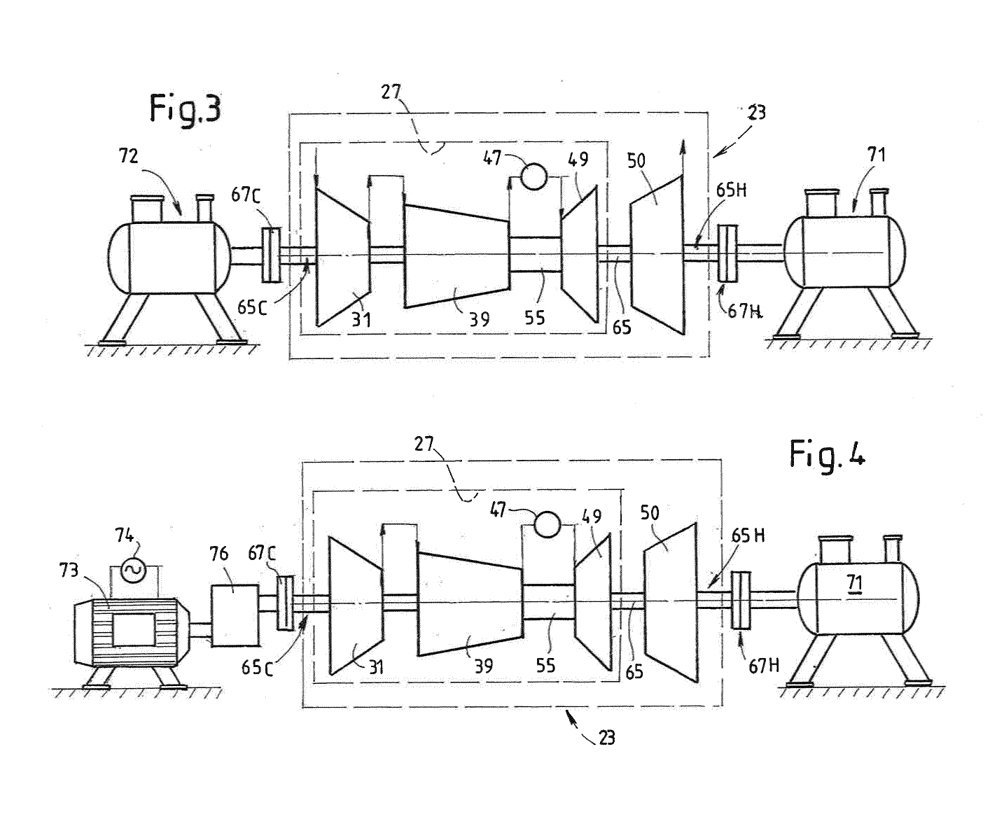

A gas turbine 23 of the kind illustrated in FIG. 2 can be used in a system schematically illustrated in FIG. 3.

In addition to the gas turbine 23, the system comprises a first load 71 and a second load 72. In the exemplary embodiment of FIG. 3, both the first load 71 and the second load 72 are centrifugal compressors, for example of an LNG line. One, the other or both compressors 71 and 72 can be of the vertical split type, with a casing designed to be opened along vertically extending planes. Since the two compressors 71 and 72 are connected on opposite sides of the gas turbine 23, each of them can be easily opened for repairing or maintenance purposes, without the need for the other compressor to be disassembled, removed or displaced.

The first compressor 71 is connected to the hot end or hot side 65H of the gas turbine 23 through a load coupling 67H comprising for example a joint, which might include a clutch or the like.

The second compressor 72 is connected to the cold end or cold side 65C of the gas turbine 23 by means of a second load coupling 67C, including for instance a joint, a clutch or both.

In the exemplary embodiment illustrated in FIG. 3, both compressors 71 and 72 are driven at the same rotary speed and in the same direction as the low pressure turbine 50. In other embodiments (not shown) a gearbox can be provided between the load coupling 67H and the respective compressor 71 and/or between the load coupling 65C and the compressor 72. The gear-box can be used to reverse the rotation direction and/or to modify the ratio between the turbine rotary speed and the rotary speed of the respective compressor 71 and/or 72.

In other embodiments (not shown), if more than two compressors must be driven by the same gas turbine 23, one or more additional compressors can be arranged at one or both ends 65H, 65C of the gas turbine 23.

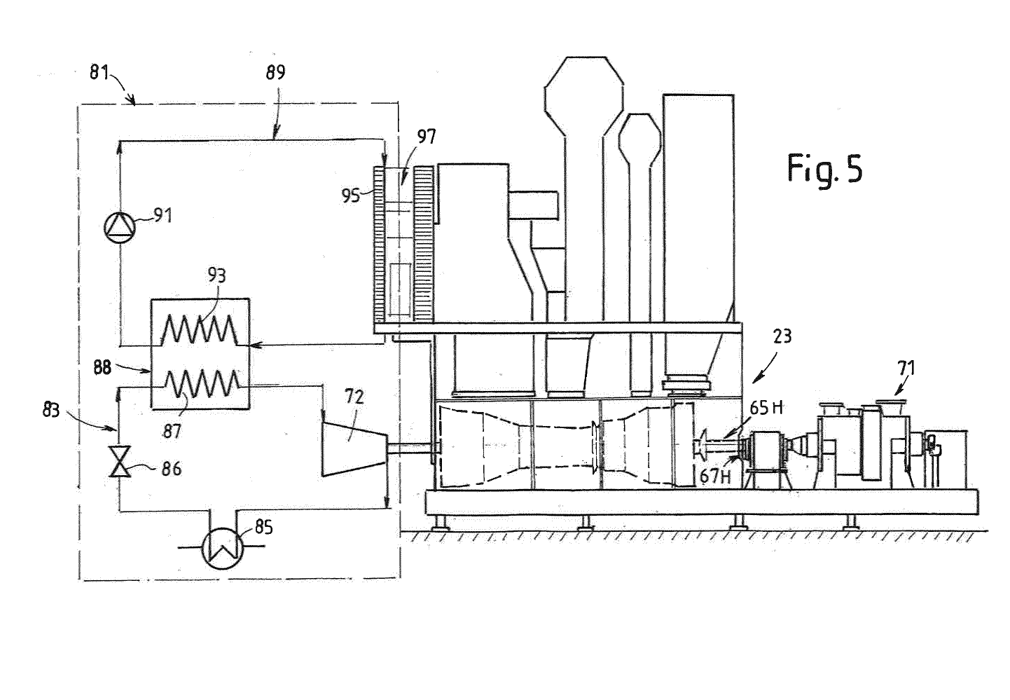

FIG. 4 illustrates a second embodiment of a system according to the present disclosure. The same reference numbers indicate the same or equivalent parts as in FIG. 3. More specifically, the embodiment of FIG. 4 includes a gas turbine 23 comprising a gas generator 27 and a low pressure turbine 50.

The gas turbine 23 of FIG. 4 can be of the same kind shown in FIG. 2. The various components of the gas turbine 23 are not described again.

In the embodiment of FIG. 4 a first load 71 and a second load 73 are drivingly connected to the hot side or hot end 65H and to the cold side or cold end 65C of the gas turbine 23, respectively. In the embodiment illustrated in FIG. 4 the first load 71 is again a compressor, for example a centrifugal compressor, while the second load 73 is an electric generator. The electric generator 73 can be connected to an electric distribution grid 74. The electric grid 74 can be a local grid for powering electric facilities connected to the gas turbine 23 and/or to the plant in which the gas turbine 23 is arranged. In the exemplary embodiment of FIG. 4, a gearbox 76 is arranged between the gas turbine 23 and the electric generator 73, to increase the rotary speed. The compressor 71 can once again be a vertically split compressor, as schematically shown in the drawing.

In the exemplary embodiment of FIG. 4 the compressor 71 is arranged at the hot end of the gas turbine 23, while the electric generator 73 is arranged at the cold end of the gas turbine 23. In other embodiments, the position of the two loads 71, 73 can be reversed, with the compressor being arranged at the hot end of the gas turbine and the electric generator arranged at the hot end of the gas turbine.

FIG. 5 schematically illustrates a further system including a gas turbine 23 as shown for example in FIG. 2, a first load 71 and a second load 72. In the example illustrated in FIG. 5 the first load 71 is again a compressor, for example a centrifugal compressor, driven by the power shaft 65 of the gas turbine 23 through a load coupling 67H arranged at the hot end or hot side 65H of the gas turbine 23.

In this embodiment the second load 72 comprises a compressor of a chilling system 81 designed and arranged for chilling the combustion air entering the gas turbine 23.

In the embodiment illustrated in FIG. 5, the chilling system 81 comprises a refrigerating circuit 83 including the above mentioned compressor 72, a condenser 85, expander or a throttling valve 86 and an evaporator 87 forming part of a heat exchanger 88. A refrigerating fluid circulates in the refrigerating circuit 83, is compressed by compressor 72 and condensed in the condenser 85, heat being removed from the refrigerating fluid in the condenser 85 by means of heat exchange with air or water, for example. The refrigerated and condensed refrigerating fluid is then expanded in expander 86 and flows through the evaporator 87 to remove heat from a fluid circulating in a secondary circuit 89. The fluid circulating in the secondary circuit 89 can be for instance cooling water.

The secondary circuit 89 comprises a pump 91 which circulates the cooling fluid, e.g. water, through a heat exchanger 93 arranged to exchange heat in the heat exchanger 88 against the refrigerating fluid circulating in the refrigerating circuit 83. The water cooled in the heat exchanger 88 flows then through a second heat exchanger 95 arranged at the inlet of an air suction duct 97, through which the combustion air is sucked by the compressors 31 and 39. In this way, the combustion air contacts the water heat exchanger 95 which cools the air to a temperature lower than the ambient temperature, thereby increasing overall efficiency of the gas turbine 23. In advantageous embodiments, the chilling system 81 can be controlled such that the combustion air is maintained at a substantially constant air temperature when entering an air intake plenum at the cold end of the gas turbine 23, said air temperature being set in order to maximize the overall efficiency of the gas turbine 23.

FIG. 5 therefore illustrates an integrated chilling system, wherein the compressor of the refrigerating circuit is driven directly by the gas turbine. A separate electric motor for driving the chilling compressor can be dispensed with, making the system simpler, less cumbersome and with reduced footprint.

In a modified embodiment, not shown, the load 71 of the system shown in FIG. 5 can be an electric generator instead of a compressor.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

1. A gas turbine system, comprising:
a gas turbine, wherein at least a first load and a second load are powered by the gas turbine, and the gas turbine comprises:
a gas generator;
a low pressure turbine; and
a power shaft powered by the low pressure turbine, the power shaft comprising a first shaft end drivingly connected to the first load and a second shaft end drivingly connected to the second load, the first load and the second load being arranged at opposite sides of the gas turbine, and the power shaft axially extending through the gas turbine from a first end to a second end thereof.

2. The gas turbine system according to claim 1, wherein the gas generator further comprises:
at least one air compressor;
a combustor; and
a high pressure turbine,
wherein the combustor is arranged for receiving compressed air from the at least one air compressor and fuel, combustion gases generated by the combustor expands in the high pressure turbine, and the power shaft extends coaxially to the at least one air compressor and the high pressure turbine.

3. The gas turbine system according to claim 1, wherein the gas turbine further comprises in combination and sequentially arranged:
a low pressure compressor;
a high pressure compressor, sequentially arranged downstream of the low pressure compressor and receiving air compressed by the low pressure compressor;
a combustor, arranged for receiving compressed air from the high pressure compressor, and fuel;
a high pressure turbine receiving combustion gases from the combustor and arranged for generating mechanical power from the combustion gases partially expanding therein, the high pressure turbine being in fluid communication with the low pressure turbine, the combustion gases from the high pressure turbine expanding in the low pressure turbine; and
a second shaft drivingly connecting the high pressure turbine and the high pressure compressor;
wherein the power shaft and the second shaft are coaxially arranged, and the power shaft drivingly connects the low pressure turbine and the low pressure compressor.

4. The gas turbine system according to claim 3, further comprising an air bleeding arrangement between the low pressure compressor and the high pressure compressor.

5. The gas turbine system according to claim 1, wherein at least one of the first load and said second load comprises a first compressor, wherein the first compressor comprises a vertically split casing.

6. The gas turbine system according to claim 5, wherein the other of the first load and the second load comprises a second compressor.

7. The gas turbine system according to claim 6, wherein the second compressor comprises a respective vertically split casing.

8. The gas turbine system according to claim 1, wherein the second load comprises an electric generator.

9. The gas turbine system according to claim 6, wherein the first compressor and optionally the second compressor are arranged and configured to process at least one refrigeration gas in a natural gas liquefaction system.

10. The gas turbine system according to claim 1, further comprising an air chilling system arranged for chilling an air stream entering the gas generator, wherein the air chilling system comprises a refrigerating circuit with a compressor processing a refrigerating fluid circulating in the refrigerating circuit, and wherein the compressor of the refrigerating circuit is mechanically connected to one of the first shaft end and the second shaft end, forming one of the first load and the second load powered by the gas turbine.

11. The gas turbine system according to claim 1, wherein the first shaft end is arranged at a cold end of the gas turbine and the second shaft end is arranged at a hot end of the gas turbine.

12. The gas turbine system according to claim 1, wherein the compressor of the refrigerating circuit is drivingly connected to the first shaft end at the cold end of the gas turbine.

13. The gas turbine system according to claim 8, wherein the electric generator is arranged and configured to electrically power auxiliary apparatuses of the gas turbine.

14. The gas turbine system according to claim 1, wherein the electric generator is drivingly connected to the first shaft end of the power shaft at the cold end of the gas turbine.

15. The gas turbine system according to claim 1, wherein the gas turbine is an aeroderivative gas turbine.

16. A method of operating a gas turbine system comprising a load, the method comprising:
providing a gas generator, a low pressure turbine, and a power shaft comprising a first shaft end and a second shaft end accessible at a first end and at a second end of the gas turbine system, respectively;
drivingly connecting a first load to the first shaft end, and a second load to the second shaft end;
generating mechanical power by low pressure turbine;
using a first part of the mechanical power through a first load coupling to drive the first load, and a second part of the mechanical power through a second load coupling to drive the second load.

17. The method according to claim 16, further comprising converting at least one of the first part and the second part of the mechanical power generated by the low pressure turbine into electric power.

18. The method according to claim 16, further comprising:
compressing air sequentially in a first, low pressure compressor at a first pressure value and in a second, high pressure compressor at a second pressure value, higher than the first pressure value;
delivering the air compressed at the second pressure value to a combustor;
generating combustion gases in the combustor;
expanding the combustion gases in a high pressure turbine;
driving the second, high pressure compressor by the high pressure turbine through a second shaft, coaxial to the power shaft;
expanding the combustion gases, discharged from the high pressure turbine, in the low pressure turbine;
driving the first, low pressure compressor by the low pressure turbine through the power shaft; and
delivering mechanical power available on the power shaft partly to the first load and partly to the second load.

19. The method according to claim 16, wherein at least one of the first load and the second load comprises at least one respective compressor with a vertically split casing.

20. The method according to claim 16, further comprising driving a compressor of a chilling system through the power shaft, wherein the chilling system comprises a compressor drivingly coupled to one end of the power shaft, and wherein the chilling system chills an intake air stream delivered to the gas turbine system.
